(19) United States
(12) Patent Application Publication
(10) Pub. No.: US 2007/0108296 A1
(43) Pub. Date: May 17, 2007

(54) Radio frequency identification devices and methods

(76) Inventors: John A. Konopka, Feeding Hills, MA (US); Bruce M. Torrey, Orlando, FL (US)

Correspondence Address: EVEREST INTELLECTUAL PROPERTY LAW GROUP, P. O. BOX 708, NORTHBROOK, IL, 60065, US

(21) Appl. No.: 11/273,572

(22) Filed: Nov. 14, 2005

(51) Int. Cl. G06K 19/00; G06K 19/06

(52) U.S. Cl. 235/492; 235/487

(57) ABSTRACT

The present invention provides compatibility of radio frequency identification (RFID) with devices that interfere with radio signals. An RFID tag is positioned at a particular location inside of a chamber of a device or object to be identified, such as a metallic chamber of a pallet, and spaced away from metallic structures by a gap. The RFID tag is tuned to the chamber by positioning the tag at a location in which radio waves entering the chamber are reflected and received by the RFID tag rather than being absorbed or affected by interference. Because of the tuning, the device or object to be identified is utilized as an antenna for the RFID tag. The RFID tag can be integrated into the structure carrying the tag rather than merely attached to the structure, for example on an outside surface.

### BACKGROUND OF THE INVENTION

The present invention generally pertains to radio frequency identification (RFID) devices. More specifically, the present invention pertains to RFID compatibility with devices that interfere with radio signals, such as metallic devices. In an embodiment, the present invention pertains to RFID for material handling pallets. The present invention also pertains to RFID methods.

Radio signals have been used for identification of objects. Radio frequency identification typically includes an RFID tag or transponder and a radio frequency transceiver (transmitter and receiver). The transceiver transmits a radio signal which is received by the RFID tag via an antenna. The RFID tag responds to the radio signal by transmitting its own radio signal, such as a signal having an identification number. The RFID tag radio signal is received by the transceiver. The transceiver processes the received RFID tag radio signal and identifies the RFID tag.

RFID has been used for various applications. However, RFID has exhibited problems and can be improved. For example, objects carrying the RFID tag or objects near the RFID tag can interfere with the radio signals. Radio signal interference can degrade the ability to effectively identify the RFID tag and even prevent identification.

Metallic devices and structures can interrupt or suppress radio transmission and receiver signals from RFID tags and transceiver devices. An RFID device placed directly on or in close proximity to metal can cause interference with the radio signals, thereby rendering the RFID device inoperative. Interference with the radio signals can include undesired reflection, absorption, degradation, and other negative effects on the signals. Interference with the RFID radio signals can occur with other materials as well, such as wood based products, impact modified or filled plastic resins and other materials.

Further problems with RFID can occur with the location of the RFID tag on the object carrying the RFID tag. It may be desirable to attach the RFID tag to an exterior surface of the object so the RFID tag can more effectively receive and transmit radio signals. However, the exposed RFID tag can be susceptible to impact, damage and vandalism. Also, the RFID tag may be undesirably removed from the object. Locating the RFID tag inside of the object for protection has not been acceptable because the ability of the RFID tag to receive and transmit radio signals is significantly degraded or prevented.

Of particular interest are the current trends within the material handling logistics industry, which include the tracking of goods throughout the supply chains. The most popular method utilized for product tracking are bar codes or Universal Product Codes (UPC's). However, the material handling logistics industry is in the process of moving towards supply chain tracking systems having RFID tags placed on various products. With the advent of Homeland Security issues and other productivity benefits, RFID supply chain tracking has become a focus of attention within the logistics industry.

Current RFID technology used in the material handling logistics industry involves the use of RFID tags that are in the High Frequency (HF) (3-30 MHz) range of the radio spectrum. Most commonly used RFID tags are in the 13.5 MHz radio frequency range. Developing RFID technology will tend to shift over to the Ultra High Frequency (UHF) and/or the Extremely High Frequency (EHF) ranges. This involves radio frequencies in the 900 MHz to 300 GHz range. Problems arise with the use of RFID systems for material handling systems and for other applications. One problem is incompatibility of RFID tags with metal structures and substrates, such as warehouse pallets, rack systems, containers, carts, etc. Another problem is incompatibility with other radio signal absorbing materials like wood, impact modified plastics, etc. These types of problems can occur with material handling devices, such as metal pallets, containers, and the like used throughout the material handling supply chain. Typically the placement of an RFID tag on or near a metal object will cause the radio energy to be significantly or even totally absorbed by the metal structure.

In addition to metallic structures, the exterior placement of RFID tags on wood pallets and other structures make the RFID tags particularly vulnerable to impact and damage. Additionally, wood and high-impact plastic structures can also absorb radio frequency energy and make the RFID tags much less effective. Also, the problems can occur with applications of RFID other than pallet applications.

Attempts to improve RFID systems have tended to focus on antenna systems, scanner systems, or software used to manage RFID information (middleware). However, attempts at improving RFID systems have not always been successful and have not addressed all the needs for improvement, particularly regarding interference with radio waves.

Accordingly, needs exist to improve RFID for the reasons mentioned above and for other reasons.

### SUMMARY OF THE INVENTION

The present invention provides new RFID devices and methods. The present invention also provides RFID compatibility with devices that interfere with radio signals, such as metallic devices. An RFID tag is positioned at a particular location inside of a chamber of a device or object to be identified, such as a metallic chamber of a pallet, and spaced away from metallic structures by a gap. The RFID tag is tuned to the chamber by positioning the tag at a location in which radio waves entering the chamber are reflected and received by the RFID tag rather than being absorbed or affected by interference. Because of the tuning, the device or object to be identified is utilized as an antenna for the RFID tag. The RFID tag is integrated with the radio wave interfering device such that the RFID tag is operable. The present invention is described in embodiments of material handling pallets. However, the present invention is broader than pallets and not limited to pallets.

The present invention is suitable for use with RFID systems operating at various frequencies, including High Frequency (HF) about 3-30 MHz, Very High Frequency (VHF) about 30-300 MHz, Ultra High Frequency (UHF) about 300-3000 MHz, Super High Frequency (SHE) about 3-30 GHz) and Extremely High Frequency (EHF) about 30-300 GHz. The invention allows for signal enhancement through calibration or tuning of the RFID tag attached to or in very close proximity to metallic structures. The invention can take advantage of the metallic structure and incorporates it as part of the RFID tag's antenna system to enhance performance by reflecting the radio signal off of the interior surfaces of the chamber to create a standing wave right on the RFID tag.

An RFID device according to the present invention has a device having a wall structure defining a chamber. An RFID tag is positioned inside of the chamber at a location spaced away from the wall structure by a gap such that the RFID tag can operatively receive and transmit signals.

The wall structure may have a radio wave passage to the inside of the chamber. The radio wave passage may be a hole through the wall structure. The radio wave passage may be a material substantially transparent to radio waves.

The device may further have a material which interferes with radio waves, for example, metals, wood, composites, impact modified plastics, and combinations thereof.

The RFID tag may be encapsulated in a non-metallic housing.

The chamber may be a substantially hollow chamber. The chamber may be at least partially filled with a non-metallic material. The wall structure may be configured such that at least one side of the chamber is open.

The RFID tag may be operable within the RFID device at frequencies of about 3-30 MHz, about 30-300 MHz, about 300-3,000 MHz, about 3-30 GHz, about 30-300 GHz, and combinations thereof.

The location of the RFID tag and a size of the gap can be determined such that radio waves passing into the chamber reflect off of the wall structure and are operatively received by the RFID tag.

The RFID device may also have an antenna operatively coupled to the RFID tag and extending from the RFID tag.

Another RFID device according to the present invention has a device having metallic material and a wall structure defining a chamber. The device also has a radio wave passage through the wall structure to inside of the chamber. An RFID tag is positioned inside of the chamber at a location spaced away from the wall structure such that the RFID tag can operatively receive signals passing into the chamber through the radio wave passage and operatively transmit signals out of the chamber through the radio wave passage.

The location of the RFID tag can be determined such that radio waves passing into the chamber reflect off of the wall structure and are operatively received by the RFID tag.

The RFID device may also have an antenna operatively coupled to the RFID tag and extending from the RFID tag.

The RFID device may be a pallet. The pallet can be made substantially entirely of metal.

A pallet according to the present invention has top and bottom members and support members connected to the top and bottom members, a wall structure defining a chamber and a radio wave passage through the wall structure to the chamber. The pallet also has an RFID tag positioned inside of the chamber at a location spaced away from the wall structure such that the RFID tag can operatively receive signals passing into the chamber through the radio wave passage and operatively transmit signals out of the chamber through the radio wave passage.

At least one of the top members, bottom members and support members may define the wall structure. The wall structure can be a metallic wall structure.

The pallet may also have an antenna operatively coupled to the RFID tag and extending from the RFID tag. The antenna can be contained within the chamber. The antenna can extend outside of the chamber.

The radio wave passage may be a hole through the wall structure. The radio wave passage may be a material substantially transparent to radio waves.

The pallet may have a material which interferes with radio waves, for example metals, wood, composites, impact modified plastics, and combinations thereof.

The RFID tag may be encapsulated in a non-metallic housing.

The chamber may be a substantially hollow chamber. The chamber may be at least partially filled with a non-metallic material. The wall structure may be configured such that at least one side of the chamber is open.

The RFID tag may be operable within the pallet at frequencies of about 3-30 MHz, about 30-300 MHz, about 300-3,000 MHz, about 3-30 GHz, about 30-300 GHz, and combinations thereof.

The location of the RFID tag can be determined such that radio waves passing into the chamber reflect off of the wall structure and are operatively received by the RFID tag.

A method of enabling a device to be identified by RFID according to the present invention provides positioning an RFID tag within a chamber of the device at a tuned location such that radio waves passing into the chamber reflect off of internal walls of the chamber and are operatively received by the RFID tag.

The method may also provide positioning the RFID tag by selecting the tuned location relative to metallic material of the device.

The method may also provide positioning the RFID tag within the chamber of a pallet.

A method of RFID identification according to the present invention provides passing a first radio signal into a chamber having an RFID tag, reflecting the first radio signal off of internal walls of the chamber, receiving the reflected first radio signal by the RFID tag, transmitting a second radio signal by the RFID tag, and passing the second radio signal out of the chamber.

One advantage of the present invention is to provide new RFID devices.

Another advantage of the present invention is to provide operable RFID devices having materials that interfere with radio signals.

Another advantage of the present invention is to allow non-RFID compatible products, such as an aluminum warehouse pallets, to be compatible with RFID tag systems.

An even further advantage of the present invention is to provide compatibility and performance enhancement of RFID systems with metallic objects.

Yet another advantage of the present invention is the ability to calibrate or tune RFID tags to the metallic object so that the RFID tag can be used effectively with the metallic object.

A further advantage of the present invention is to provide RFID for pallets.

Yet another advantage of the present invention is to provide improved pallets.

An advantage of the present invention is to provide metallic pallets with RFID.

Another advantage is to provide new RFID methods.

Additional features and advantages of the present invention are described in, and will be apparent from, the following Detailed Description of the Invention and the figures. The features and advantages may be desired, but, are not necessarily required to practice the present invention.

### BRIEF DESCRIPTION OF THE FIGURES

FIG. 1 is a perspective view of an RFID device according to the present invention.

FIG. 2 is a top view of the RFID device of FIG. 1.

FIG. 3 is a top view of another RFID device according to the present invention.

FIG. 4 is a top view of another RFID device according to the present invention.

FIG. 5 is a front view of another RFID device according to the present invention.

FIG. 6 is a cross-sectional view along the line VI-VI of FIG. 5.

FIG. 7 is a top view of a pallet according to the present invention.

FIG. 8 is an end view of the pallet of FIG. 7.

FIG. 9 is an enlarged view of an RFID tag of the pallet of FIG. 8.

FIG. 10 is a top view of another pallet according to the present invention with a top deck removed.

FIG. 11 is an exploded view of another pallet according to the present invention.

FIG. 12 is an exploded view of another pallet according to the present invention.

FIG. 13 is a schematic view of another pallet according to the present invention.

### DETAILED DESCRIPTION OF THE INVENTION

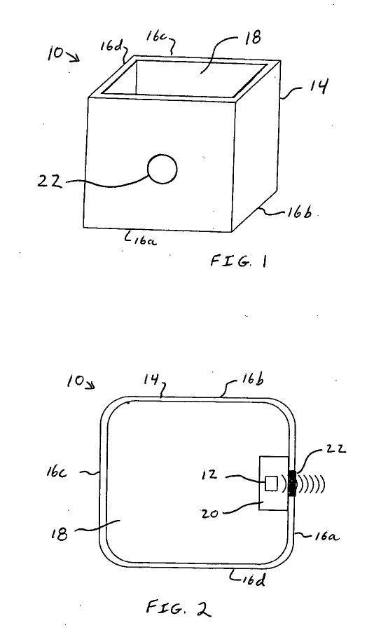

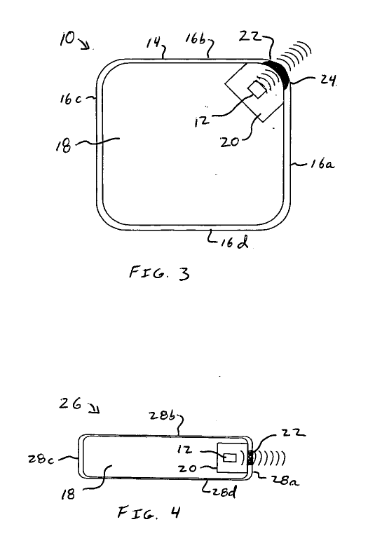

One example of an RFID device 10 according to the present invention is shown in FIGS. 1 and 2. The RFID device 10 has an RFID tag 12 attached to a device 14. The RFID tag 12 can be a known RFID tag usable with RFID systems. The device 14 having the RFID tag 12 has a wall structure forming a chamber 18. In this embodiment the wall structure is defined by walls 16a, 16b, 16c, 16d of the device 14. The device 14 is shown in FIGS. I and 2 without a top wall and a bottom wall. Accordingly, the chamber 18 has open sides at the top and bottom. However, the device 14 may have top and bottom walls forming a fully enclosed chamber 18. Numerous other wall structures forming different shaped chambers can be utilized. The chambers can be fully enclosed or partially open by having one or more areas of the wall structure being open. The entire wall structure or portions of the wall structure of the device 14 can be made of a metal material or other material that reflects radio waves. The inside surfaces of the walls 16a-d of the device 14 could be coated with a radio wave reflective material.

The RFID tag 12 is positioned inside of the chamber 18 at a desired location. The RFID tag 12 may be encased in a housing 20, for example a non-metallic housing. One housing 20 according the present invention has a thickness of about ⅜ inch. The RFID tag outer housing 20 may be used to locate the RFID tag 12 at the desired position and to attach the RFID tag 12 to the wall 16a inside of the chamber 18. The inside of the chamber 18 could include a mounting structure, such as notches, where the encapsulated RFID tag 12 would lock into place. Other mounting structures can be used to attach the RFID tag 12 to the device 14 as well. The chamber 18 does not have to be completely hollow. The chamber 18 could be partially or fully filled with a material that permits passage of radio waves to and from the RFID tag 12.

The wall 16a of the device 14 has a radio wave passage 22, such as an open hole, through the wall 16a. The RFID tag 12 is mounted to the device 14 within the chamber 18 in alignment with the radio wave passage 22. The radio wave passage or hole 22 through the wall 16a can be a single hole or multiple holes. Also, the size, shape and location of the hole can be defined as needed to effectively allow the radio waves the pass into and out of the chamber 18. For example, the structure of the hole may be adjusted depending on the wavelength of the radio waves. A relatively smaller hole may be used for higher frequency radio waves, and a relatively larger hole may be used for lower frequency radio waves. The radio wave passage 22 does not have to be an open hole as any structure that allows passage of the radio waves would be suitable. For example, the radio wave passage 22 could be a hole filled with a plug or covered with a material that permits passage of the radio waves, i.e. a radio wave transparent material. Another alternative for the radio wave passage 22 is a portion of the wall 16a could be made of a material that allows passage of the radio waves.

The location of the RFID tag 12 within the chamber 18 can be an important aspect of some embodiments of the present invention. The RFID tag 12 is positioned inside of the chamber 18 at a desired position relative to the radio wave reflective wall structure. The desired position of the RFID tag 12 allows for the radio signals to be effectively received by the RFID tag 12 and allows for the RFID tag 12 to effectively transmit radio signals. The RFID tag 12 is spaced from the radio wave reflective walls 16a-d by desired gaps. The gaps allow the radio waves to reflect off of the internal surfaces of the chamber 18 and operatively contact the RFID tag 12. The gaps between the RFID tag 12 and the walls 16a-d can be provided by encapsulating the RFID tag 12 inside of the non-metallic material housing 20. In the embodiment of FIGS. 1 and 2, the thickness of the encapsulating non-metallic material housing 20 defines the gap between the RFID tag 12 and the wall 16a to which the encapsulating non-metallic material housing 20 is mounted.

The RFID device 10 is tuned by adjusting the position of the RFID tag 12 within the chamber 18 to allow operative reception of the signal. This position is a tuned position or location of the RFID tag 12. The ability to vary the distance of the RFID tag 12 from the surrounding wall structure, e.g. metallic chamber surfaces, allows radio waves to reflect off of the wall structure inside the chamber 18 to create a standing wave right on the RFID tag 12, thereby enhancing performance. Adjusting the gaps around the RFID tag 12 to any of the surfaces of the wall structure—which can be a metallic wall structure—allows for the RFID tag 12 to be calibrated or tuned to the device 14 or the metallic wall structure. If the RFID tag 12 is placed in an incorrect position or untuned position, then the interference with the radio waves may degrade the operability of the RFID device 10 or even render the RFID device inoperable with an RFID system.

The tuned location of the RFID tag can be determined by various factors, for example operating frequency of the RFID tag, configuration of the wall structure, degree of radio wave interference caused by the device carrying the RFID tag, mass of metallic material, effective reception of radio wave signals by the RFID tag, and combinations thereof. The tuning effect of the present invention is particularly applied to UHF's and above, i.e. RFID tags operating in the UHF, VHF, SHF and EHF ranges. The wavelengths of such high frequency waves are relatively short and the antennas of the corresponding RFID tags can also have relatively short length. The RFID tags which operate at such high frequencies can operate at multiples of the full frequency wavelengths, for example ½ wavelength, ¼ wavelength, ⅛ wavelength, 1/32 wavelength, etc. The sizes of the chambers containing the RFID tags of the present invention are generally relatively small. The tuning effect of the present invention provides reflecting the relatively high frequency radio wave inside of the chamber back to an antenna of the RFID tag at one of the frequency wavelength multiples in the same phase making a stronger signal for reception by the antenna of the RFID tag. That is the tuning effect. RFID tags which operate at HF's and below generally require relatively longer antennas because the wavelengths are long. Small sized chambers may not be large enough to reflect the full wavelength of lower frequency waves to be received by the antenna of the RFID tag.

The RFID tag 12 can also be positioned at a desired location inside of the chamber 18 relative to the radio wave passage 22. The RFID tag 12 can be aligned with the radio wave passage 22 so that radio waves entering the chamber 18 can directly strike the RFID tag 12 and radio waves transmitted by the RFID tag 12 can easily exit the chamber 18. The location of the radio wave passage 22 can be adjusted to achieve effective operable RFID communication rather than or in addition to changing the position of the RFID tag 12. The relative location of the RFID tag 12 and the radio wave passage 22 is adjusted to permit radio waves entering the chamber 18 to reflect off of the internal surfaces of the wall structure and to allow radio waves transmitted from the RFID tag 12 to exit the chamber 18 for reception by a transceiver.

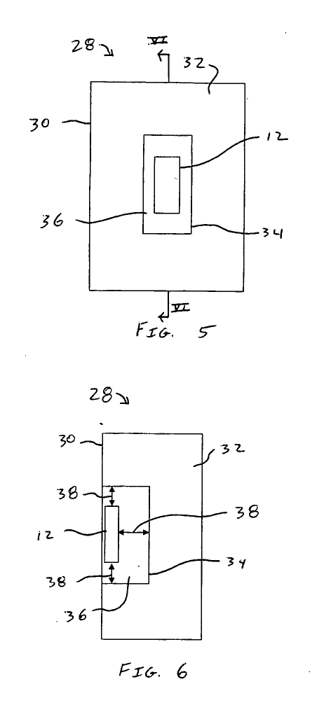

FIG. 3 shows the RFID device 10 of FIGS. 1 and 2 with an alternative mounting location for the RFID tag 12 at a corner 24. The radio wave passage 22 is also located at the corner 24. FIG. 4 shows another example of an RFID device 26. The RFID device 26 is similar to the RFID device 10 of FIGS. 1 and 2, with a different wall structure having walls 28a-d.

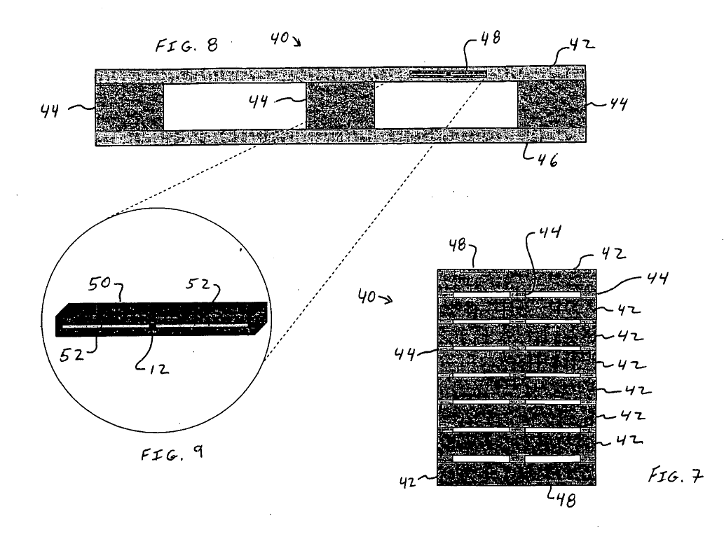

Referring to FIGS. 5 and 6, another embodiment of the present invention is shown. In this embodiment, an RFID device 28 has an RFID tag 12 embedded into a device 30. The device 30 has a solid metal portion 32, such as a metallic substrate or a metal wall, with a recess 34 which defines a chamber. The inside surfaces of the recess 34 in the device 30 is the wall structure defining the chamber. The RFID tag 12 is encapsulated with a non-metallic material 36. The RFID tag 12 with the encapsulating material 36 is inserted into the chamber 34 and can completely fill the chamber 34. Any suitable mechanism can be used to secure the RFID tag 12 within the chamber 34. For example, an adhesive can be used to bond the encapsulating material 36 to the device 30.

The RFID tag 12 is spaced from the wall structure by gaps 38. Encapsulating the RFID tag 12 with the non-metallic material 36 is one method to define the gaps 38 from the wall structure. By varying and selecting appropriate distances of the gaps 38 between the RFID tag 12 and the metallic device 30 the interference of the metallic device 30 with the radio waves is neutralized. The RFID tag 12 is tuned or located at a tuned position relative to the metallic device 30 such that the RFID tag 12 can operatively receive and transmit signals. The tuned position of the RFID tag 12 allows the radio waves entering the chamber 34 to reflect off of the wall structure to create a standing wave on the RFID tag 12 such that the RFID tag 12 is operable. Therefore, the metallic device 30 is utilized to make it an integral part of the antenna for the RFID tag 12.

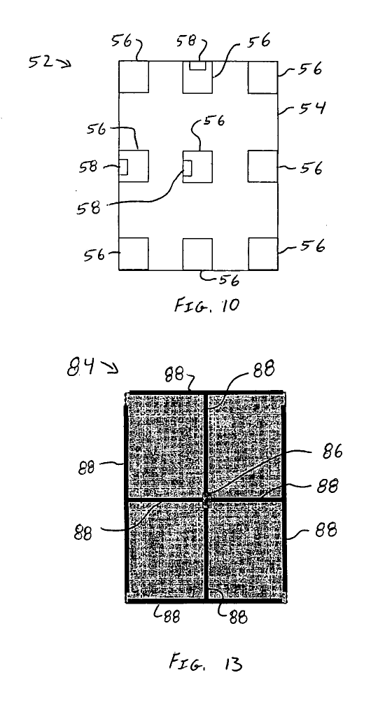

The present invention can be practiced in many different embodiments. Several embodiments pertaining to material handing pallets will now be described. FIG. 7 shows a top view of a pallet 40 which is a so-called stringer type pallet. The pallet 40 has top deck members 42 connected to support members or stringer members 44. The pallet 40 also has bottom deck members 46 shown in FIG. 8. One or more of the top deck members 42, stringer members 44 and bottom deck members 46 are made of metal material. The members 42, 44, 46 can be solid metal or hollow, and made, for example, by extrusion.

The metal pallet 40 has one or more RFID tag locations 48. FIG. 7 shows two RFID tag locations 48 at leading edges of opposite top deck members 42. However, the RFID tag location 48 could be at any desired location on the pallet 40. FIG. 8 shows an end view of the pallet 40 showing the RFID tag location 48. FIG. 9 is an enlarged view of an RFID tag 12 encapsulated in a non-metallic material 50. One or more antenna 52 may extend from the RFID tag 12 and be contained within the non-metallic material 50. The RFID tag 12 and the encapsulating non-metallic material 50 are provided in a chamber at the RFID tag location 48.

The RFID tag locations 48 can have a structure corresponding to the structure shown in FIGS. 5 and 6 in which the RFID tag 12 and the encapsulating non-metallic material 50 are embedded into a recess chamber. The RFID tag locations could also have a structure corresponding to the structures shown FIGS. 1-4. For example, the members 42, 44, 46 can be elongated, hollow and can have a structure corresponding to the RFID device 26 shown in FIG. 4.

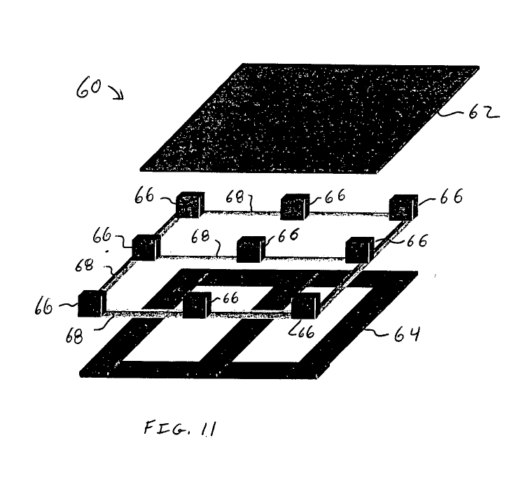

FIG. 10 shows another pallet 52 as an embodiment of the present invention. FIG. 10 shows the pallet 52 with a top deck removed for clarity. The pallet 52 has a bottom deck 54 and hollow blocks or support members 56. The pallet 52 is a so-called 9-block style pallet. The pallet top deck, bottom deck 54 and blocks 56 are made of metal material, for example aluminum. The blocks 56 have a structure like the device 14 of FIGS. 1 and 2. The pallet 52 has one or more RFID tag locations 58 inside of one or more blocks 56. The structure of the RFID tag locations 58 correspond to the RFID device 10 shown in FIGS. 1-3. The top deck (not shown) and the bottom deck 54 can be made of hollow metallic top and bottom members, respectively. The top and bottom members are elongated and can have a structure corresponding to the RFID device 26 shown in FIG. 4.

FIG. 11 shows an exploded view of another pallet 60 as an embodiment of the present invention. The pallet 60 has a top deck 62, a bottom deck 64, and blocks or support members 66 connected to the top and bottom decks 62, 64. The pallet 60 is generally made of non-metal material, such as plastic material or composite material. Accordingly, any of the pallet components of the top deck 62, bottom deck 64 and blocks 66 can be made of non-metal material. The pallet 60 also has metal reinforcements 68 to enhance the strength of the pallet 60. An RFID tag is provided on the pallet 60 in accordance with the disclosures herein. The RFID tag is operatively coupled to the metal reinforcements 68 such that the metal reinforcements 68 function as an extended antenna of the RFID tag. Embodiments of the present invention which have an antenna (for example, the metal reinforcements 68) extending outward beyond the chamber containing the RFID tag may be particularly advantageous for RFID tags operating at frequencies of HF and below. Such relatively low frequency RFID tags typically require a relatively long antenna to operate with the long wavelength frequencies.

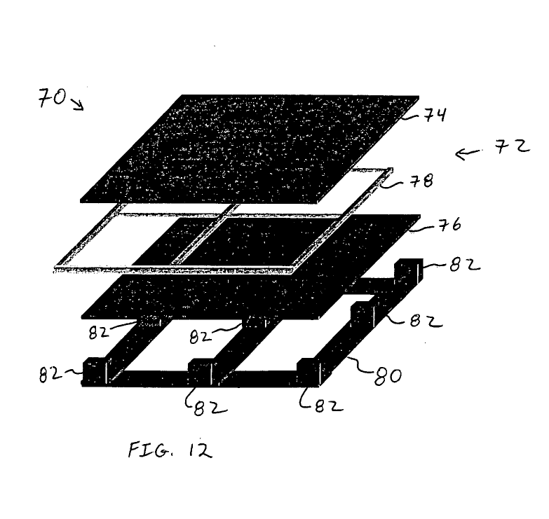

FIG. 12 shows an exploded view of another pallet 70 as an embodiment of the present invention. The pallet 70 has a top deck 72 having a top layer 74, a bottom layer 76 and metal reinforcements 78 between the top and bottom layers 74, 76. The pallet 70 also has a bottom deck 80 and blocks or support members 82 connected to the top and bottom decks 72, 80. The pallet 70 is generally made of non-metal material, such as plastic material or composite material. Accordingly, any of the pallet components of the top layer 74, bottom layer 76, bottom deck 80 and blocks 82 can be made of non-metal material. The metal reinforcements 78 enhance the strength of the pallet 70. An RFID tag is provided on the pallet 70 in accordance with the disclosures herein. The RFID tag is operatively coupled to the metal reinforcements 78 such that the metal reinforcements 78 function as an extended antenna of the RFID tag.

FIG. 13 schematically shows a top view of another pallet 84 as an embodiment of the present invention. The pallet 84 has an RFID tag location 86 having an RFID tag as disclosed herein. The RFID tag location 86 is shown as being in a middle interior portion of the pallet 84, for example inside a chamber of a center block or support member. An antenna 88, for example a wire or coaxial cable or other metallic structure, is operatively connected, for example by an inductive coupling, to the RFID tag at the RFID tag location 86. The antenna 88 extends beyond the RFID tag location 86 to various areas of the pallet 84. The antenna 88 can be attached to various surfaces of the pallet 84 or embedded into components of the pallet 84, for example embedded into plastic material of the pallet components.

The present invention allows for the RFID tag to be integrated into the structure carrying the tag rather than merely attached to the structure, for example on an outside surface. The present invention utilizes a gap or spacing between the RFID tag and the inside of a chamber that permits metallic structures, such as aluminum warehouse pallets, etc., to be compatible with the function of RFID tags. In the case of warehouse pallets, this allows standard RFID tags to be placed inside of various pallet components, for example, corner blocks, center blocks, side blocks, rails, etc.

The present invention also provides for tuning RFID tags, mainly UHF, VHF, SHF and EHF RFID tags, to a metallic structure such that the metallic structure becomes an integral part of the RFID tag antenna. This allows the ability to have RFID tags calibrated or tuned to the metallic structure carrying the tag, e.g. the pallet. The location of the RFID tag within the chamber can be adjusted which alters the gap between the tag and the chamber walls to tune the RFID tag with the metallic structure for operability of the tag.

Another aspect of the present invention is the integration and operable use of RFID tags with metal structures without the need to attach the tags externally. The RFID tags are located or tuned to the metal structures such that the metal structures actually function as an extension of the antenna of the RFID tag. The invention also allows for the calibration or tuning of metallic structures or metallic containing structures to RFID tags, mainly UHF, VHF, SHF, and EHF RFID tags. Thus, metal structures, including materials containing metallic substrates, can be made compatible with the RFID tags. In the case of HF RFID tags the invention provides RFID system compatibility with metallic structures, allowing them to function in a normal manner. The invention also allows for UHF, VHF, SHF, and EHF RFID systems to function in a normal fashion.

Another aspect of the present invention is that the RFID tags can be located within protected areas of the metal structures. The RFID tags are protected which allows the RFID tags to survive harsh environments that external tag applications cannot handle. Materials other than metal can also interfere with RFID signals, such as wood (e.g., wood containing moisture or chemicals), composite materials, high-impact plastic material structures, and plastics. The present invention can also allow RFID tags to be effectively used with those materials and other materials that interfere with RFID signals.

Another aspect of the present invention is that for RFID tags operating at HF and below an antenna can be operatively coupled to the RFID tag and extend outward beyond the chamber. The extended antenna can be a metal component of the device carrying the RFID tag or simply just and antenna, for example.

This disclosure mainly describes the present invention in terms of RFID tags. However, the term “RFID tag” is not intended to limit the scope of the invention and claims. For example, RFID devices in general can be considered as equivalent to tags when practicing embodiments of the present invention.

Material handling pallets are one example of the present invention. Pallets can be made of metal, such as aluminum, or non-metal materials or contain metal components. Such pallets have interfered with radio signals of RFID systems and have not been effectively compatible with RFID systems. The present invention allows for RFID systems to be compatible and operative with metal pallets and pallets made of other materials which interfere with radio signals.

The present invention actually takes advantage of metallic structures which previously caused interference with and inoperability of RFID systems. The metallic structures are utilized as an integral part of the antenna system for the RFID tag. The invention not only achieves compatibility of UHF, VHF, SHF and EHF RFID tags with metallic structures but also uses the metallic structure as part of the antenna system for the enhancement of the tag performance. Embodiments of the invention achieves this through tuning the RFID tag to the specific metallic structure it is attached to using the radio frequency wavelength and an air-gap.

The present invention allows for the integration of HF tags into the metallic structure or other device carrying the tag so that they may function normally. Utilization of the air gap with metallic structures actually enhances signal performance by reflecting radio signals from the internal sides of the chamber to create a standing electromagnetic wave right on the RFID tag.

Two general types of RFID tags are passive RFID tags and active RFID tags. Passive RFID tags do not have a power supply, while active RFID tags have a power supply. A passive RFID tag uses the energy from the transceiver signal to generate and transmit its RFID tag signal. An active RFID tag uses its power source, such as a battery, to transmit its RFID tag signal. Active RFID tags can generally transmit stronger signals compared to passive RFID tags because of the power supply. Due to the stronger signals, active RFID tags may have been used for applications where there is interference with the radio signals prior to the present invention. However, RFID systems having active RFID tags may be more costly to implement and maintain. The present invention can be used with passive and active RFID tags. An advantage of the present invention is that passive RFID tags, which are generally less costly than active RFID tags, can be used without the added costs associated with active RFID tags.

In some embodiments of the invention, if the RFID tag is an HF RFID tag, it may be advantageous to place the RFID tag very close to a surface of the non-metallic encasement housing to create the greatest gap between the RFID tag and the metallic wall structure. In some embodiments of the invention, the UHF, VHF, SHF, and EHF, RFID tags can take advantage of the metallic structure of the device carrying the RFID tag as part of the antenna and are calibrated or tuned in order to be operational. Calibration or tuning can be achieved by placing the RFID tag inside the non-metallic encasement housing at an optimal distance or gap from the metal wall structure based on the tag operating frequency. The optimal distance or gap provides for proper operation of the RFID tag rather than interference with the radio signals.

In an embodiment, the full wavelength for a UHF RFID tag is about 13 inches. The UHF RFID tag only has to be about 1.6 inches long for a ⅛th wavelength. A 1/32nd wavelength is about 0.4 inches. Setting the gap at about that distance from the RFID tag to any of the metal surfaces will calibrate or tune the RFID tag to the device carrying the RFID tag. The radio waves will enter the chamber, reflect back from the wall structure to create a standing wave right on the RFID tag.

The present invention and RFID compatibility and tuning also applies to plastic materials and other materials that may contain metallic components. Many plastic warehouse pallets, for example, have an internal metal framework for increased strength. These metal frameworks and/or other metallic components have radio signal interference properties that can be neutralized through the use of the present invention invention.

The present invention can also be practiced in embodiments of RFID systems. An RFID system has an RFID device according to the present invention as disclosed herein and also includes a transceiver or other communication device. The transceiver transmits a radio signal to the RFID tag. The RFID tag receives the transceiver radio signal and processes the signal. Then, the RFID tag transmits a radio signal which is received by the transceiver. The RFID tag radio signal includes identifying information. The transceiver receives the RFID tag radio signal, processes the signal and determines the identification of the RFID tag. The RFID system may also include other system components as well, for example antennas, microprocessors, input devices and output devices.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. An RFID device, comprising:
a device having a wall structure defining a chamber; and
an RFID tag positioned inside of the chamber at a location spaced away from the wall structure by a gap such that the RFID tag can operatively receive and transmit signals.

2. The RFID device of claim 1, wherein the wall structure has a radio wave passage to the inside of the chamber.

3. The RFID device of claim 2, wherein the radio wave passage comprises a hole through the wall structure.

4. The RFID device of claim 2, wherein the radio wave passage comprises a material substantially transparent to radio waves.

5. The RFID device of claim 1, wherein the device further comprises a material which interferes with radio waves selected from the group consisting of metals, wood, composites, impact modified plastics, and combinations thereof.

6. The RFID device of claim 1, wherein the RFID tag is encapsulated in a non-metallic housing.

7. The RFID device of claim 1, wherein the chamber is a substantially hollow chamber.

8. The RFID device of claim 1, wherein the chamber is at least partially filled with a non-metallic material.

9. The RFID device of claim 1, wherein the wall structure is configured such that at least one side of the chamber is open.

10. The RFID device of claim 1, wherein the RFID tag is operable at frequencies selected from the group consisting of about 3-30 MHz, about 30-300 MHz, about 300-3,000 MHz, about 3-30 GHz, about 30-300 GHz, and combinations thereof.

11. The RFID device of claim 1, wherein the location of the RFID tag and a size of the gap are determined such that radio waves passing into the chamber reflect off of the wall structure and are operatively received by the RFID tag.

12. The RFID device of claim 1, further comprising an antenna operatively coupled to the RFID tag and extending from the RFID tag.

13. An RFID device, comprising:
a device having metallic material and a wall structure defining a chamber;
a radio wave passage through the wall structure to inside of the chamber; and
an RFID tag positioned inside of the chamber at a location spaced away from the wall structure such that the RFID tag can operatively receive signals passing into the chamber through the radio wave passage and operatively transmit signals out of the chamber through the radio wave passage.

14. The RFID device of claim 13, wherein the location of the RFID tag is determined such that radio waves passing into the chamber reflect off of the wall structure and are operatively received by the RFID tag.

15. The RFID device of claim 13, further comprising an antenna operatively coupled to the RFID tag and extending from the RFID tag.

16. The RFID device of claim 13, wherein the device is a pallet.

17. The RFID device of claim 16, wherein the pallet is made substantially entirely of metal.

18. A pallet, comprising:
top and bottom members;
support members connected to the top and bottom members;
a wall structure defining a chamber and a radio wave passage through the wall structure to the chamber; and
an RFID tag positioned inside of the chamber at a location spaced away from the wall structure such that the RFID tag can operatively receive signals passing into the chamber through the radio wave passage and operatively transmit signals out of the chamber through the radio wave passage.

19. The pallet of claim 18, wherein at least one of the top members, bottom members and support members defines the wall structure.

20. The pallet of claim 19, wherein the wall structure is a metallic wall structure.

21. The pallet of claim 18, further comprising an antenna operatively coupled to the RFID tag and extending from the RFID tag.

22. The pallet of claim 21, wherein the antenna is contained within the chamber.

23. The pallet of claim 21, wherein the antenna extends outside of the chamber.

24. The pallet of claim 18, wherein the radio wave passage comprises a hole through the wall structure.

25. The pallet of claim 18, wherein the radio wave passage comprises a material substantially transparent to radio waves.

26. The pallet of claim 18, wherein the pallet further comprises a material which interferes with radio waves selected from the group consisting of metals, wood, composites, impact modified plastics, and combinations thereof.

27. The pallet of claim 18, wherein the RFID tag is encapsulated in a non-metallic housing.

28. The pallet of claim 18, wherein the chamber is a substantially hollow chamber.

29. The pallet of claim 18, wherein the chamber is at least partially filled with a non-metallic material.

30. The pallet of claim 18, wherein the wall structure is configured such that at least one side of the chamber is open.

31. The pallet of claim 18, wherein the RFID tag is operable at frequencies selected from the group consisting of about 3-30 MHz, about 30-300 MHz, about 300-3,000 MHz, about 3-30 GHz, about 30-300 GHz, and combinations thereof.

32. The pallet of claim 18, wherein the location of the RFID tag is determined such that radio waves passing into the chamber reflect off of the wall structure and are operatively received by the RFID tag.

33. A method of enabling a device to be identified by RFID, comprising positioning an RFID tag within a chamber of the device at a tuned location such that radio waves passing into the chamber reflect off of internal walls of the chamber and are operatively received by the RFID tag.

34. The method of enabling a device to be identified by RFID of claim 33, wherein positioning the RFID tag further comprises selecting the tuned location relative to metallic material of the device.

35. The method of enabling a device to be identified by RFID of claim 34, wherein positioning the RFID tag further comprises positioning the RFID tag within the chamber of a pallet.

36. A method of RFID identification, comprising:
passing a first radio signal into a chamber having an RFID tag;
reflecting the first radio signal off of internal walls of the chamber;
receiving the reflected first radio signal by the RFID tag;
transmitting a second radio signal by the RFID tag; and
passing the second radio signal out of the chamber.
